(19) United States
(12) Patent Application Publication
(10) Pub. No.: US 2005/0261918 A1
(43) Pub. Date: Nov. 24, 2005

(54) Business protocol policy injection

(75) Inventors: Derek W. Carr, Fairless Hills, PA (US); Peter P. Eacmen, West Roxbury, MA (US); Ronny A. Pena, New York, NY (US); Ajamu A. Wesley, Concord, MA (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/848,188

(22) Filed: May 18, 2004

(51) Int. Cl. G06F 17/60

(52) U.S. Cl. 705/1

(57) ABSTRACT

The present invention is a method, system and apparatus for for dynamic business protocol based policy injection in a cross-enterprise business process management system. In accordance with the present invention, a defined business process can be re-factored to permit the handling of business process transformation events. Moreover, one or more mappings to the event handlers can be registered as can one or more business transformation operatives configured to specify the activation of specific business activities at particular places within the business process. Once re-factored, the business process can be “seeded” with a business process transformation policy. Subsequently, upon receipt of a business process transformation event, the instance of the business transformation operative can be located and the specific business activities can be activated and the business process can be suitably configured according to the mapped business transformation operatives and through the operation of the event handlers.

### BACKGROUND OF THE INVENTION

1. Statement of the Technical Field

The present invention relates to the field of computerized business-to-business interactions and more particularly to integrating cross enterprise business processes.

2. Description of the Related Art

The achievement of universal interoperability between applications by using Web standards remains the principal goal of Web Services. Web Services use a loosely coupled integration model to allow flexible integration of heterogeneous systems in a variety of domains including business-to-consumer, business-to-business and enterprise application integration. The following basic specifications originally defined the Web Services space: the Simple Object Access Protocol (SOAP), the Web Services Description Language (WSDL), and Universal Description, Discovery, and Integration (UDDI). SOAP defines an XML messaging protocol for basic service interoperability. WSDL introduces a common grammar for describing services. UDDI provides the infrastructure required to publish and discover services in a systematic way. Together, these specifications allow applications to find each other and interact following a loosely coupled, platform-independent model.

Presently, the interaction model that is directly supported by WSDL essentially can be viewed as a stateless model of synchronous or uncorrelated asynchronous interactions. Models for business interactions typically assume sequences of peer-to-peer message exchanges, both synchronous and asynchronous, within stateful, long-running interactions involving two or more parties. Nevertheless, systems integration requires more than the mere ability to conduct simple interactions by using standard protocols. The full potential of Web Services as an integration platform will be achieved only when applications and business processes are able to integrate their complex interactions by using a standard process integration model.

The Business Process Execution Language for Web Services (BPEL4WS) fulfills some aspects of a standard process integration model. The BPEL4WS specification defines a technology for integrating cross-enterprise business processes. By coordinating stateful interactions of loosely coupled services across enterprise boundaries, the BPEL4WS technology provides a means of modeling the interactions between an enterprise and its business partners, suppliers and customers and thus the value chain of the enterprise. More particularly, BPEL4WS defines a notation for specifying business process behavior based on Web Services.

In accordance with the BPEL4WS notation, business processes export and import functionality by using Web Service interfaces exclusively. Business processes can be described in two ways. First, executable business processes model the actual behavior of a participant in a business interaction. Abstract business protocols, by comparison, use process descriptions that specify the mutually visible message exchange behavior of each of the parties involved in the protocol without revealing their internal behavior. In any case, the BPEL4WS specification can be used to model the behavior of both executable and abstract processes.

BPEL4WS provides a language for the formal specification of business processes and business interaction protocols. By doing so, BPEL4WS extends the Web Services interaction model and enables the model to support business transactions. The basic concepts of BPEL4WS can be applied in one of two ways. A BPEL4WS process can define a business protocol role, using the notion of an abstract process. The relationship between two or more business protocol roles can be modeled as a partner link. Similarly, it is also possible to use BPEL4WS to define an executable business process. In an executable business process, the logic and state of the process determine the nature and sequence of the Web Service interactions conducted at each business partner, and thus the interaction protocols.

Importantly, where private implementation aspects of a business process use platform-dependent functionality, which is likely in many if not most realistic cases, the continuity of the basic conceptual model between abstract and executable processes in BPEL4WS makes it possible to export and import the public aspects embodied in business protocols as process or role templates while maintaining the intent and structure of the protocols. This is arguably the most attractive prospect for the use of BPEL4WS from the viewpoint of unlocking the potential of Web Services. Specifically, BPEL4WS allows the development of tools and other technologies that greatly increase the level of automation and thereby lower the cost in establishing cross-enterprise automated business processes.

Notwithstanding, BPEL4WS can be limited to the static deployment of selected business processes. In fact, whereas BPEL4WS provides for a statically specified abstract business protocol for a deployed process, BPEL4WS does not permit the dynamic specification of an abstract business protocol for a deployed process. More concisely, the business process execution environment does not define a process for adapting business protocols or executable business processes as a function of business insights modeled as business policies. The modern, on-demand computing vision, however, demands that the enterprise support a level of business transformation which is informed by timely and relevant business insights. Consequently, comprehensive business transformations require not only the modification of executable business processes, but also the adaptation of partner, supplier and customer interactions modeled by BPEL4WS as business protocols, or abstract processes.

### SUMMARY OF THE INVENTION

The present invention addresses the deficiencies of the art in respect to cross-enterprise business process interaction and provides a novel and non-obvious method, system and apparatus for business protocol based policy injection in a cross-enterprise business process management system. In accordance with the present invention, a cross-enterprise business process management system can include a business process specification document processing engine configured to process business process specification documents.

Each of the documents can describe a business process having one or more business protocols defined therein. Moreover, the business process can include a sequence of business activities embodied within corresponding Web services. In a preferred aspect of the invention, the business process specification documents can include business process execution language (BPEL) documents. In this regard, the business process specification document processing engine can include a business process execution language for Web services (BPEL4WS) run-time engine.

The system further can include a deployment service coupled to the engine and programmed to generate and deploy service instances supporting corresponding ones of the business protocols defined in the business process. Importantly, a registry of event personas and business transformation operatives can be included in the system as can a business transformation engine coupled to the business process specification document processing engine. The business transformation engine can be configured to process transformation scripts for changing the business process. Specifically, the business transformation engine can process transformation scripts by activating and deactivating selected ones of the business protocols in the business process according to registered ones of the event personas and business transformation operatives.

Each of the transformation scripts can include at least one sub-expression. The sub-expressions can include a conditional expression correlated to an actionable expression. The conditional expression can map to one of the event personas. Similarly, the actionable expression can map to one of the business transformation operatives. Finally, the system can include a registry of un-actuated links. Each of the un-actuated links can correspond to a corresponding one of the business protocols.

In a method for business protocol based policy injection in a cross-enterprise business process management system, the method can include re-factoring a business process specification document to incorporate event handlers for each scope in the document that provides one of getting and setting a variable in the scope. Each activity specified in the document can be converted to an un-actuated XLink. Also, at least one business transformation operative (BTO) responsible for at least one specific business transformation action can be registered as can at least one event persona associated with a corresponding one of the event handlers. Finally, a business process can be seeded for a business protocol transformation with at least one business protocol transformation policy based upon a combination of a registered BTO and a registered event persona.

In a preferred aspect of the invention, the seeding step can include the step of processing a transformation script to produce and register an informed BTO based upon a conditional expression mapped to a corresponding registered event persona and an actionable expression mapped to a corresponding registered BTO. The method also can include correlating a received event to a registered event persona and locating a registered informed BTO based upon the correlated event persona. A scope of insertion can be identified for the informed BTO in the document and variables in the scope can be initialized according to the event handlers in the scope. Consequently, an XLink for a specific business transformation identified in the informed BTO can be actuated a business protocol extension to the business protocol can be invoked through the actuated XLink.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a cross-enterprise business process interaction system which has been configured for dynamic business protocol based policy injection in accordance with the inventive arrangements;

FIG. 2 is a flow chart illustrating a process for deploying partner link services in the system of FIG. 1 to support dynamic business protocol based policy injection responsive to a business transformation;

FIG. 3 is a block diagram of a BPEL document configured for modification according to the deployment process of FIG. 2; and,

FIG. 4 is a flow chart illustrating a process for policy seeding the system of FIG. 1 to support dynamic business protocol based policy injection responsive to a business transformation; and,

FIG. 5 is a flow chart illustrating a process for changing a business protocol responsive to a business transformation.

### DETAILED DESCRIPTION OF THE PREFERRED EMBODIMENTS

The present invention is a method, system and apparatus for dynamic business protocol based policy injection in a cross-enterprise business process management system. In accordance with the present invention, the business process management system can be adapted to permit the variable modification of a defined business process. In this regard, a defined business process can be re-factored to permit the handling of business process transformation events. Moreover, one or more mappings to the event handlers can be registered as can one or more business transformation operatives configured to specify the activation of specific business activities at particular places within the business process.

Once the defined business process has been re-factored, the business process can be “seeded” with a business process transformation policy. In this regard, the policy can be processed to identify specific conditional correlations with both the registered mappings to the event handlers and also the registered business transformation operatives. The resulting seed can be registered as an instance of a business transformation operative. Subsequently, upon receipt of a business process transformation event, the instance of the business transformation operative can be located and the specific business activities can be activated and the business process can be configured according to the mapped business transformation operatives and through the operation of the event handlers. In this way, the business process can be modified dynamically according to the policy without requiring a complete manual re-tooling of the business process.

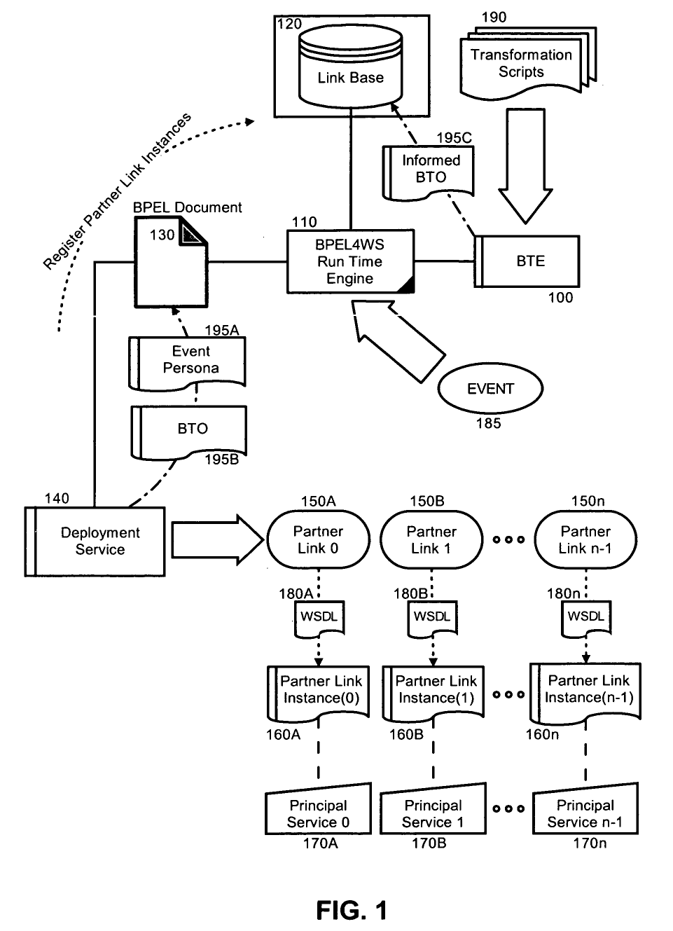

FIG. 1 is a schematic illustration of a cross-enterprise business process interaction system which has been configured for dynamic business protocol based policy injection in accordance with the inventive arrangements. The system can include a business process specification document processing engine configured to process business process specification documents. Business process specification documents are documents—typically markup language documents—which define the sequence of a business process. Typically associated with Web services, the business process specification documents also include information regarding the location and addressability of Web services programmed to implement activities in the sequence of the business process.

In a preferred aspect of the invention, the business process specification document processing engine can be a business process execution language (BPEL) run-time engine 110. As such, the BPEL run-time engine 110 can be configured to process a BPEL conforming document 130 by deploying Web services to support the activities of the business process defined within the BPEL document 130. In this regard, the BPEL run-time engine 110 can process a sequence of defined activities in the BPEL document 130 to identify a workflow of activities in the BPEL document 130, and also a set of messages responsive to which the BPEL run-time engine 110 can manage the invocation of selected ones of the deployed Web services. As an example, the BPEL run-time engine 110 can be a BPEL run-time engine configured to process BPEL4WS compliant documents.

A deployment service 140 can be coupled to the BPEL run-time engine 110. The deployment service 140 can be configured to re-factor artifacts associated the BPEL document 130, including for example, the BPEL document 130 itself in addition to corresponding WSDL documents. A link base authority 120 can be communicatively linked to the deployment service 140. The link base authority 120 can be a Web service programmed to manage an XLink link base document. The link base document can serve as a registry for all information related to the business process described in the BPEL document 130. Importantly, the BPEL run-time engine 110 can be configured with an XLink interpreter (not shown) to process Xlinks in the link base authority 120.

One or more partner links 150A, 150B, 150n can be defined within the BPEL document 130, each of the partner links 150A, 150B, 150n representing a role in the business process described within the BPEL document 130. For each defined partner link 150A, 150B, 150n, a corresponding partner link instance 160A, 160B, 160n can be created as a Web service along with a WSDL document 180A, 180B, 180n. The partner link instances 160A, 160B, 160n can embody the role of corresponding partner links 150A, 150B, 150n defined within the BPEL document 130. Each of the partner link instances 160A, 160B, 160n further can include a specification of an endpoint address for a principal service 170A, 170B, 170n designated to support the role associated with a corresponding one of the partner links 150A, 150B, 150n.

In accordance with the inventive arrangements, a business transformation engine (BTE) 100 can be coupled to the BPEL run-time engine 110. The BTE 100 can be a Web service extension to the BPEL run-time engine 100. The BTE 100 can be programmed to process transformation scripts 190. Each of the scripts 190 can express business insights and business agreements coordinated with business transformation actions. Specifically, each of the scripts 190 can include conditional expressions which trigger actions responsive to the detection of mapped business transformation events. To that end, event handlers can be associated with the conditional expressions during the deployment process of the BPEL document 130.

In operation, when deploying a new business process defined by the BPEL document 130, the deployment service 140 can generate partner link instances 160A, 160B, 160n for each partner link 150A, 150B, 150n defined in the BPEL document 130. In particular, each of the partner link instances 160A, 160B, 160n can be created based upon a corresponding WSDL document 180A, 180B, 180n provided to the deployment service 140 in association with the BPEL document 130. Notably, each of the partner link instances 160A, 160B, 160n can include a skeletal structure acting as an interface to the underlying ones of the principal services 170A, 170B, 170n. When bound and deployed as a Web service, each of the partner link instances 160A, 160B, 160n thus can act as a proxy for corresponding ones of the principal services 170A, 170B, 170n.

The deployment service 140, having created the partner link instances 160A, 160B, 160n can register each of the partner link instances 160A, 160B, 160n with the link base authority 120. In this way, any one of the partner link instances 160A, 160B, 160n can be notified when an endpoint reference to a corresponding one of the principal services 170A, 170B, 170n has changed. Once the partner link instances 160A, 160B, 160n have been registered with the link base authority, the BPEL document 130 and its corresponding WSDL document (not shown) can be refactored so that the partner link instances 160A, 160B, 160n are utilized in lieu of a direct utilization of the principal services 170A, 170B, 170n. Specifically, the WSDL documents 180A, 180B, 180n for each partner link 150A, 150B, 150n can be modified to point to the newly deployed partner link instances 160A, 160B, 160n.

Within the BPEL document 130 itself, an event handler can be added for updating the endpoint reference information of the partner link instances 160A, 160B, 160n. The WSDL document (not shown) for the BPEL document 130 also can be updated to reflect the addition of the event handler. In any case, once the BPEL document 130 and the companion WSDL document (not shown) have been re-factored, one or more XLinks for the business can be registered with the link base authority 120. In this regard, each XLink can bind a partner link 150A, 150B, 150n to a principal service 170A, 170B, 170n by way of the partner link instances 160A, 160B, 160n. Finally, the re-factored BPEL document 130 and the companion WSDL document (not shown) can be deployed along with the WSDL documents 180A, 180B, 108n by the BPEL run-time engine 110.

In addition to adding the event handler for updating the endpoint reference, additional event handlers can be generated for each scope in the BPEL document 130 that provides the function of getting or setting each variable in the scope. Moreover, a set of event personas 195A can be registered in the link base authority 120. An event persona 195A can correlate a specific event handler disposed in the BPEL document 130 with a conditional expression associated with the activation of a business transformation. Where multiple events are associated with the same conditional expression, the event persona 195A further can include conflict resolution logic.

Business transformation operatives 195B can be registered in the link base authority 120 in reference to supporting particular business transformation actions in the business process defined in the BPEL document 130. Each business transformation operative (BTO) 195B can support a declarative model including its own deployment descriptor which provides the necessary information to support the registration of the BTO. The BTO deployment descriptor can include references to all associated BPEL artifacts including both BPEL and WSDL documents along with any relevant endpoint reference based information. The BTO 195B also can include information regarding the prospective location within a deployed business process represented as an XLink reference to an immersed activity.

In the present invention, the transformation of a business process can be defined according to a specified policy. To that end, transformation scripts 190 can define sub-expressions correlating conditional expressions to actionable expressions. The BTE 100 can map the conditional expressions in the transformation scripts 190 to a registered event persona 195A. Similarly, the BTE 100 can map the actionable expressions to a registered BTO 195B. Where the sub-expressions can be resolved by the BTE 100, an “informed” BTO can be registered as an instance of the sub-expression for use during the triggering of a transformation event 185.

Specifically, when a business process transformation event 185 is received in the BPEL run-time engine 110, the event can be correlated to an “informed” BTO. Once the event can be matched to the informed BTO, the event persona 195A associated with the informed BTO can be retrieved and processed to locate and activate a suitable event handler. Similarly, the registered BTO 195B can be retrieved and processed to identify the relevant portion of the BPEL document 130 in which an immersed activity is to be placed and activated in order to transform the business process.

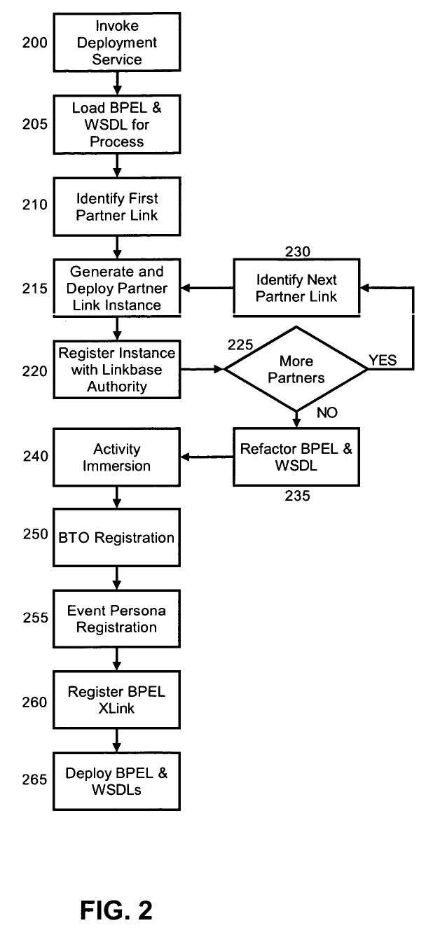

Turning now to FIG. 2, a flow chart is shown which illustrates a process for deploying partner link services in the system of FIG. 1 to support dynamic binding of partner links to endpoint services and also dynamic business protocol based policy injection. Beginning in block 200, the deployment service can be invoked. Specifically, the deployment service can be invoked by calling the deploy operation of the BPEL run-time engine and by passing a BPEL document and a companion WSDL document to the deployment service. Additionally, the WSDL documents for the partner links specified in the BPEL document further can be passed to the deployment service.

In block 205, the BPEL document and companion WSDL document can be loaded for processing. In block 210, a first partner link can be identified in the BPEL document. In block 215, a partner link instance can be generated and deployed for the first partner link. Specifically, the WSDL document for the identified partner link can be used to generate a skeleton and a service that reflects the actual interface of a corresponding principal service. The partner link instance can be bound and deployed as a Web service which acts as a proxy for the principal service. An exemplary WSDL fragment follows:

```
<wsdl:service name = “MyPTService”>
  <wsdl:port binding=“namespace:MyServiceSoapBinding”
  name=“MyService”>
    <wsdlsoap:address location=“http://localhost:8080/appserver/
    MyAuxService”/>
  </wsdl:port>
</wsdl:service>
```

In block 220, the partner link instance can be registered with the link base authority. An exemplary XLink fragment follows:

```
<baseResource id=“PRIMARY_SERVICE_AUX”
xlink:type=“extended”>
  <baseResourceRef xlink:type=“locator”
  xlink:href=“http://mycompany.com/primary_service_aux”
  xlink:role=“PARTNER_LINK_INSTANCE”
  xlink:label=“PRIMARY_SERVICE_AUX” />
</baseResource>
```

In particular, the registration of the partner link instance can result in the notification of the partner link instance when its associated endpoint reference to a supporting principal service has changed. In blocks 225 and 230, the process of generating and deploying partner link instances for identified partner links, and also of registering the partner link instances with the link base authority can repeat for each identified partner link in the BPEL document. Subsequently, the process can continue in block 235 through block 265.

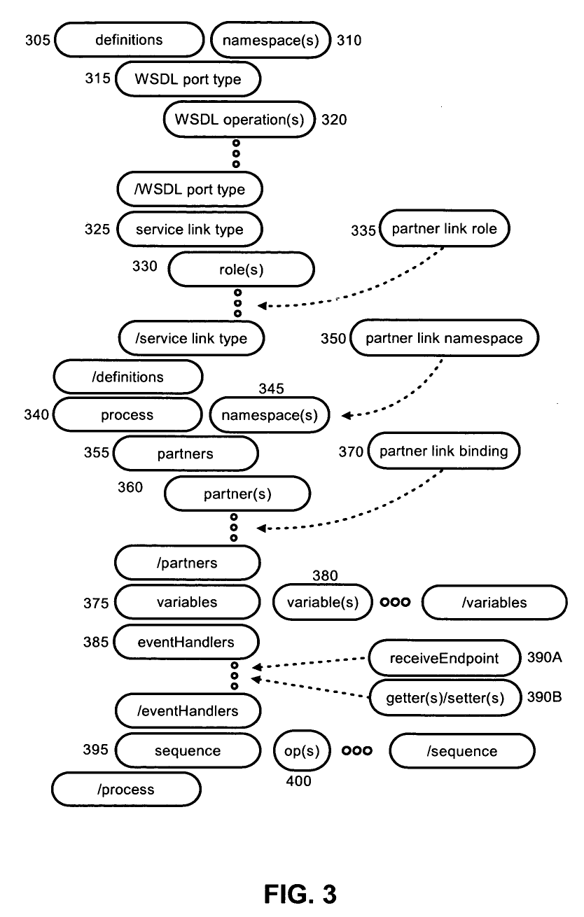

In particular, in block 235 the BPEL document and the WSDL document for the business process can be re-factored. More particularly, each partner link specified in the BPEL document can be changed to reflect a correspondence to the partner link instance created and deployed in block 215. Also, event handlers can be established for each scope in the BPEL document that provide the function of getting or setting each variable in the scope. In more particular illustration, FIG. 3 is a block diagram of a BPEL document configured for modification according to the deployment process of FIG. 2. The BPEL document illustrated in FIG. 3 can include a definitions portion 305 in which a namespace 310 can be defined, a WSDL port type 315 having one or more defined WSDL operations 320 can be defined, and a service link type 325 having one or more roles 330 can be defined.

Notably, a process portion 340 can be included in the BPEL document. The process portion 340 can specify one or more namespaces 345 and can incorporate a partners section 355 having one or more defined partner links 360, a variables 375 section having one or more defined variables 380, and a sequence section 395 having one or more operations 400 defined therein. During the re-factoring process of the present invention, a reference to partner link instance 335 can be added to the BPEL document as can a partner link instance namespace definition 350 for the namespace of the partner link instance 335. A binding 370 to the WSDL document for the partner link instance 335 further can be added to the partners section 355 of the BPEL document. Finally, an event handling section 385 can be added in which an event 390A can be defined for handling a change in reference endpoint to a principal service.

Importantly, the event handling section 385 also can be augmented to include one or more getter/setter event handlers 390B for each scope in the BPEL document that provides either or both of a getting or setting function for each variable in the scope. The establishment of the getter/setter event handlers 390B can allow business protocols added at a specific point in the original business protocol flow to get and set variable values outside of its own document. For any new business protocol that may be added at a specific point in the original business protocol, the protocol can contain variable declarations for any scoped variable in the context of the original business protocol that are initialized and returned via the generated event handlers.

Returning now to FIG. 2, in block 240 an activity immersion step can include the conversion of every BPEL activity to an un-actuated XLink. The un-actuated XLink can serve as a means to provide extensions to the business protocol. The XLink can have a specific role that represents it as a business transforamtion link. Each link can be registered with the link base authority and each link can have a status describing how to act responsive to actuation. For example, the link can reference a third party arc in the link base, but that arc may be followed either before or after the execution of the current activity or both. An exemplary immersion of a BPEL activity can produce the following link:

```
<invoke partner=“primary_supplier”
  portType=“namespace:supplierSLT”
  operation=“receivePurchaseOrder”
  inputVariable=“purchaseOrder”
  outputVariable=“invoice”
  xlink:type=“simple”
  xlink:role=“http://mycompany.com/bizXformLink”
  xlink:href=“http://linkbaseAuthority/linkBaseAuthority”
  xlink:actuate=“other”
  status=“activity.pre” | “activity.post” | “activity.both”
  xlink:arcrole=“http://www.w3.org/xlink/properties/linkbase/”
/>
```

In block 250, each BTO can be registered with the link base authority. Additionally, in block 255 each event persona can be registered with the link base authority. In block 260, the XLinks for the business process defined in the BPEL document can be registered with the link base authority. In this regard, an XLink stored in the link base authority can bind the partner link role to the principal service along with the partner link instance to a partner link. If a partner link is mapped to a new principal service, then the partner link instance that is mapped to a specific partner link can be updated with a new endpoint address. Finally, in block 265 the re-factored BPEL document and the re-factored WSDL document can be deployed for use by the BPEL run-time engine.

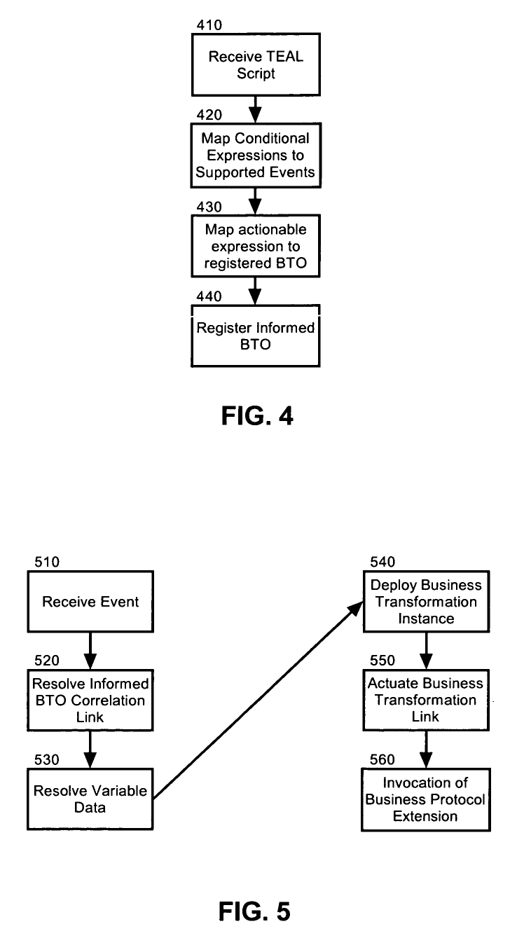

A multi step process can be defined for the insertion of a policy injection process relative to business transformation scripts allowing for the dynamic transformation of a business protocol. In more particular illustration, FIG. 4 is a flow chart illustrating a process for policy seeding the system of FIG. 1 to support dynamic business protocol based policy injection responsive to a business transformation. Beginning in block 210 a transformation script can be received as input into the BTE. An exemplary transformation script can include one or more conditional expressions in the form of “If [conditional_expression] then [actionable_expression]”.

In block 420, each conditional expression specified in the transformation script can be mapped to an event persona. Specifically, when an event persona first is registered with the link base authority, the event persona can be correlated to one or more sub-expressions. Thus, when processing a transformation script, the BTE can search the set of registered event persona in the link base authority to locate a specific event persona instance that claims a correlation with a conditional expression identified in the transformation script. If no suitable event persona instance can be located for the conditional expression, the BTE can reject the transformation script.

In block 430, each actionable expression in the transformation script can be mapped to a registered BTO. Similar to the event persona instance, each BTO can be registered in association with a corresponding set of actionable expressions. Consequently, when processing a transformation script, the BTE can search the set of registered BTOs in the link base authority to locate a BTO corresponding to the conditional expression. Finally, in step 440, once the BTE has located an event persona instance and a BTO for the conditional expression, the BTE can register an informed BTO with the link base authority. The informed BTO can represent an instance of the transformation scxript.

Once the informed BTO has been registered, events can trigger the informed BTO to change the business protocol. In further illustration, FIG. 5 is a flow chart illustrating a process for changing a business protocol responsive to a business transformation. Beginning in block 510, an event can be received that represents a registered event persona. In block 520, a registered informed BTO can be correlated to the received event. Subsequently, in block 530 variable data within the scope of the insertion of the BTO instance can be inserted and resolved. Specifically, the insertion and resolution can include inserting all variable definitions in the parent BPEL document that are in scope, and initializing these values using the getter event handlers generated when deploying the parent BPEL. Upon termination of execution, the child BPEL represented by the informed BTO can set its parent variable values using the appropriate setter event handlers.

In block 540 the business transformation instance can be deployed. In particular, once the BTE locates an informed BTO which correlates to a received event, the informed BTO can be interpreted to trigger the deployment of a BPEL sub process described in the BTO. Notably, the BTO can include information relative to its insertion point in the business protocol. As such, the information can translate into a specific business transformation link within a specific business protocol. This link can be actuated in block 550. Finally, in block 560 upon actuation of the business transformation link, the invocation of the business protocol extension can be enabled through an XLink reference.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A cross-enterprise business process management system comprising:
a business process specification document processing engine configured to process business process specification documents, each of said documents describing a business process having a plurality of business protocols defined therein;
a deployment service coupled to said engine and programmed to generate and deploy service instances supporting corresponding ones of said business protocols defined in said business process;
a registry of event personas and business transformation operatives; and,
a business transformation engine coupled to said business process specification document processing engine and configured to process transformation scripts for changing said business process by activating and deactivating selected ones of said business protocols in said business process according to registered ones of said event personas and business transformation operatives.

2. The system of claim 1, wherein said business process specification documents comprise business process execution language (BPEL) documents.

3. The system of claim 2, wherein said business process specification document processing engine comprises a business process execution language for Web services (BPEL4WS) run-time engine.

4. The system of claim 1, wherein each of said transformation scripts comprises at least one sub-expression comprising a conditional expression correlated to an actionable expression, said conditional expression mapping to one of said event personas and said actionable expression mapping to one of said business transformation operatives.

5. The system of claim 1, wherein said business process comprises a sequence of business activities embodied within corresponding Web services.

6. The system of 1, further comprising a registry of un-actuated links, each link corresponding to a corresponding one of said business protocols.

7. A method for business protocol based policy injection in a cross-enterprise business process management system, the method comprising the steps of:
re-factoring a business process specification document to incorporate event handlers for each scope in said document that provides one of getting and setting a variable in said scope;
converting each activity specified in said document to an un-actuated XLink;
registering at least one business transformation operative (BTO) responsive for at least one specific business transformation action, and further registering at least one event persona associated with a corresponding one of said event handlers; and,
seeding a business process for a business protocol transformation with at least one business protocol transformation policy based upon a combination of a registered BTO and a registered event persona.

8. The method of claim 7, wherein said seeding step comprises the step of processing a transformation script to produce and register an informed BTO based upon a conditional expression mapped to a corresponding registered event persona and an actionable expression mapped to a corresponding registered BTO.

9. The method of claim 8, further comprising the steps of:
correlating a received event to a registered event persona;
locating a registered informed BTO based upon said correlated event persona;
identifying a scope of insertion for said informed BTO in said document and initializing variables in said scope according to said event handlers in said scope;
actuating an XLink for a specific business transformation identified in said informed BTO; and,
invoking a business protocol extension to the business protocol through said actuated XLink.

10. The method of claim 9, wherein said locating step further comprises the step of resolving conflicts between multiple event handlers and said at least one event persona.

11. A machine readable storage having stored thereon a computer program for business protocol based policy injection in a cross-enterprise business process management system, the computer program comprising a routine set of instructions which when executed by a machine causes the machine to perform the steps of:
re-factoring a business process specification document to incorporate event handlers for each scope in said document that provides one of getting and setting a variable in said scope;
converting each activity specified in said document to an un-actuated XLink;
registering at least one business transformation operative (BTO) responsive for at least one specific business transformation action, and further registering at least one event persona associated with a corresponding one of said event handlers; and,
seeding a business process for a business protocol transformation with at least one business protocol transformation policy based upon a combination of a registered BTO and a registered event persona.

12. The machine readable storage of claim 11, wherein said seeding step comprises the step of processing a transformation script to produce and register an informed BTO based upon a conditional expression mapped to a corresponding registered event persona and an actionable expression mapped to a corresponding registered BTO.

13. The machine readable storage of claim 12, further comprising the steps of:
correlating a received event to a registered event persona;
locating a registered informed BTO based upon said correlated event persona;
identifying a scope of insertion for said informed BTO in said document and initializing variables in said scope according to said event handlers in said scope;
actuating an XLink for a specific business transformation identified in said informed BTO; and,
invoking a business protocol extension to the business protocol through said actuated XLink.

14. The machine readable storage of claim 13, wherein said locating step further comprises the step of resolving conflicts between multiple event handlers and said at least one event persona.
